(19) United States
(12) Patent Application Publication
(10) Pub. No.: US 2006/0242955 A1
(43) Pub. Date: Nov. 2, 2006

(54) Hydraulic system with piston pump and open center valve

(75) Inventor: Adam R. Mauch, Mooreton, ND (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Clark Equipment Company, Montvale, NJ (US)

(21) Appl. No.: 11/109,260

(22) Filed: Apr. 19, 2005

(51) Int. Cl. F16D 31/02

(52) U.S. Cl. 60/422

(57) ABSTRACT

The present invention includes one illustrative embodiment that relates to a system that includes a piston pump, an open center valve, and an electronic controller. The piston pump is configured to provide a pressurized flow, such as to the open center valve. The open center valve is fluidly coupled to the piston pump, and configured thereby to receive the pressurized flow from the piston pump. The electronic controller is electrically connected to the piston pump. The electronic controller is also configured to receive operator input and to electronically control the piston pump, responsively to the input, to provide the pressurized flow to the first open center valve at a flow rate that is selectable from a range that is continuously variable from zero flow to a preselected maximum. Additional embodiments include, for example, a means for electronically controlling the piston pump, or a power machine with a frame, ground engaging members, and an engine. Among other advantages, embodiments offer continuous variability of flow rates, thereby improving cycle times and allowing selectable flow to a given attachment, for example. The flow can also be reduced to zero when there are no functions demanding it, thereby saving power and improving cooling, and the piston pump may be controlled electronically instead of with load sense signals, among additional advantages in various embodiments.

### BACKGROUND OF THE INVENTION

The present invention relates to a fluid system, and particularly to a hydraulic circuit with a piston pump and an open center valve.

Many traditional hydraulic circuit systems use a gear pump with a closed center valve. A need has been felt, in some applications, for a more efficient and flexible hydraulic circuit system.

### SUMMARY OF THE INVENTION

The present invention includes providing pressurized flow from a piston pump to an open center valve, among other purposes. In one illustrative embodiment, this pressurized flow is provided at a flow rate that is selectable from a range that is continuously variable from zero flow to a preselected maximum, e.g. the flow limit of the preselected piston pump. This continuous variability improves cycle times, for instance for attachment lift or tilt cycle times, and allows selectable flow to each of one or more attachments, in one illustrative embodiment. The flow can also be reduced to zero when there are no functions demanding it, thereby saving power and improving cooling. The piston pump may be controlled electronically instead of with load sense signals, in one illustrative embodiment.

The present invention is useful in a variety of applications, including in a power machine of the types useful for utility, industrial, commercial, logistical, and agricultural purposes, for example.

The present invention includes one illustrative embodiment that relates to a system that includes a piston pump, an open center valve, and an electronic controller. The piston pump is configured to provide a pressurized flow, such as to the open center valve. The open center valve is fluidly coupled to the piston pump, and configured thereby to receive the pressurized flow from the piston pump. The electronic controller is electrically connected to the piston pump. The electronic controller is also configured to receive operator input and to electronically control the piston pump, responsively to the input, to provide the pressurized flow to the first open center valve at a flow rate that is selectable from a range that is continuously variable from zero flow to a preselected maximum.

Another illustrative embodiment pertains to a fluid system that includes a piston pump, an open center valve, and a means for electronically controlling the piston pump. The piston pump is configured to provide a pressurized flow. The open center valve is fluidly coupled to the piston pump, and configured thereby to receive the pressurized flow from the piston pump. The means for electronically controlling the piston pump controls it responsively to operator input, to provide the pressurized flow to the open center valve. It provides the pressurized flow at a flow rate that is selectable from a range that is continuously variable from zero flow to a preselected maximum.

Yet another illustrative embodiment pertains to a power machine that includes a frame, a plurality of ground engaging members, an engine, a piston pump, an open center valve, and an electronic controller. The plurality of ground engaging members, such as wheels or tracks, for example, support the frame. The engine is operably connected to the ground engaging members. The piston pump is connected to the frame, and is driven by the engine. The open center valve is connected to the frame, and fluidly coupled to the piston pump. The open center valve is thereby configured to receive a pressurized flow from the piston pump. The electronic controller is electrically connected to the piston pump. The electronic controller electronically controls the piston pump to provide the pressurized flow to the open center valve at a flow rate that is selectable from a range that is continuously variable from zero flow to a preselected maximum.

### BRIEF DESCRIPTION OF THE DRAWINGS

FIG. 1 schematically depicts a system according to one illustrative embodiment.

FIG. 2 schematically depicts a system according to another illustrative embodiment.

FIG. 3 depicts a partially cutout side view of a power machine according to another illustrative embodiment.

FIG. 4 is a fragmented, cutaway depiction of a system according to another illustrative embodiment.

FIG. 5 schematically depicts a system according to another illustrative embodiment.

### DETAILED DESCRIPTION OF ILLUSTRATIVE EMBODIMENTS

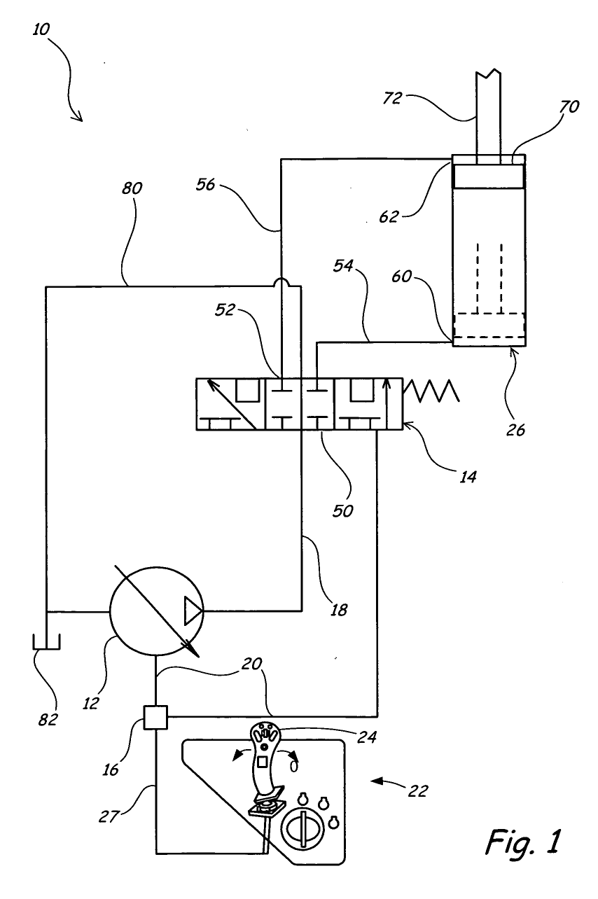

FIG. 1 depicts a fluid system 10, according to one illustrative embodiment. System 10 includes piston pump 12, open center valve 14, and electronic controller 16. Piston pump 12 is configured to provide a pressurized flow along downstream fluid coupling 18. Open center valve 14 is fluidly coupled to piston pump 12 via fluid coupling 18. Open center valve 14 is thereby configured to receive pressurized flow from piston pump 12.

In this illustrative embodiment, electronic controller 16 is electrically connected to piston pump 12, and to open center valve 14, via signal-carrying electrical connections 20. Electronic controller 16 is configured to receive operator input, and to electronically control the piston pump 12 responsively to that operator input. Electronic controller 16 thereby electronically controls piston pump 12 to provide the pressurized flow to open center valve 14, in this illustrative embodiment. Other embodiments may include other means for electronically controlling the piston pump, responsively to operator input, to provide the pressurized flow to the open center valve 14 at a flow rate that is selectable from a range that is continuously variable from zero flow to a preselected maximum. For example, the preselected maximum is the flow limit of the preselected piston pump 12, in this illustrative embodiment.

In this illustrative embodiment, electronic controller 16 controls piston pump 12 to provide the pressurized flow at a flow rate that is selectable from a range that is continuously variable from zero flow to a preselected maximum. The flow rate is continuously variable in that the flow rate can be selected freely from a continuum of optional rates, the continuum of flow rates being bounded on one side by zero and on the other side by the maximum flow of which piston pump 12 is capable.

By allowing the option of any flow rate being selectable from a continuum of available flow rates, including any rate down to zero, the system of FIG. 1 provides substantial advantages. For example, when there are no tasks to be done, oil flow through the open center valve 14 can be reduced to a reduced flow rate, anywhere down to zero flow. This saves horsepower and improves cooling of the system, for example.

In one alternative embodiment consistent with the system 10 of FIG. 1, the flow rate of the pressurized flow provided by the piston pump 12 is selectably controlled exclusively through the electronic controller 16. In such an embodiment, the flow rate of the pressurized flow provided by the piston pump 12 may be selectably controlled exclusively as a function of the operator input. The operator may therefore freely select the flow rate, without the flow rate also being determined in part by, for example, load sense signals or other forms of input from, for example, feedback processes from the system 10. In this embodiment, the electronic controller 16 is configured to receive the operator input through an operator interface 22 that comprises a joystick 24, and to which electronic controller 16 is connected via signal-carrying electrical connection 27. An operator is able to manipulate joystick 24 to provide the sole input determining flow rate, in this embodiment. For example, the flow rate may be proportional to the angular displacement of the joystick 24, in this embodiment. In other embodiments, additional factors such as feedback from system 10 may be included along with an operator input in determining flow rate.

The embodiment of system 10 in FIG. 1 further includes an actuator 26 fluidly coupled to the open center valve 14, wherein the open center valve 14 is configured to provide the pressurized flow selectively to the actuator 26. The actuator 26 is a double-acting, single cylinder fluid cylinder, in this embodiment, and includes a piston 70 and a single rod 72. In other embodiments, the actuator may be a single-acting cylinder or a double-acting cylinder, a single-rod cylinder or a double rod cylinder, or other type of cylinder or other actuator in various embodiments.

To illustrate an operation of system 10, if the open center valve 14 is shifted to the left, as seen in FIG. 1, responsively to an operator input, fluid would pass from fluid coupling 18 through port 50 of valve 14, through fluid coupling 54 to port 60 of actuator 26. Fluid would also be forced from port 62 of actuator 26 through fluid coupling 56 and port 52 of valve 14, to downstream fluid coupling 80. Fluid coupling 80 connects with oil reservoir 82, and with piston pump 12 to complete the circuit. The fluid directed to port 60 of actuator 26, at the selected flow rate and at a given pressure, provides a selected level of power to actuator 26, to perform a task desired by the operator.

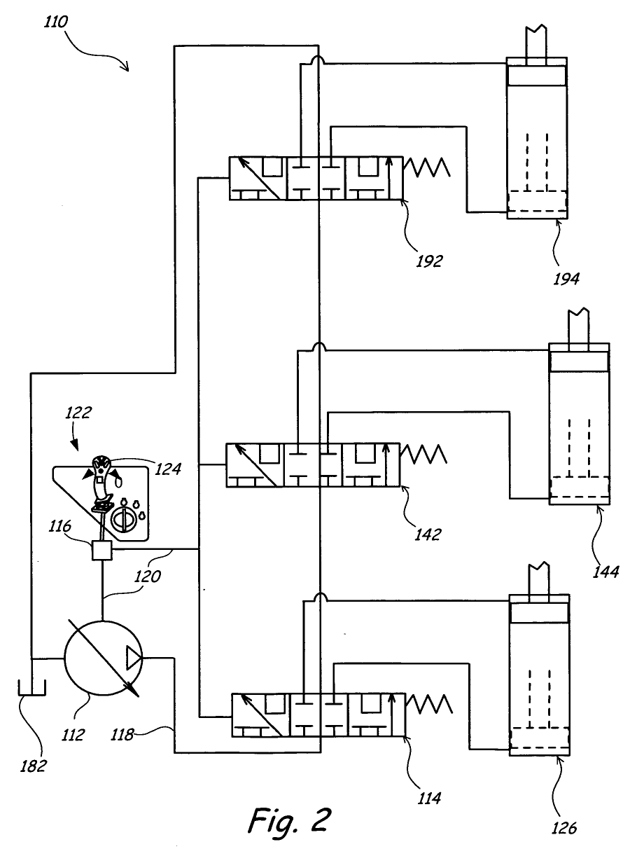

FIG. 2 depicts a system 110 analogous in some ways to system 10 of FIG. 1. System 110 includes piston pump 112, first open center valve 114, and electronic controller 116, downstream fluid coupling 118, electrical connection 120, operator interface 122, joystick 124, first actuator 126, and oil reservoir 182 disposed with respect to each other in a manner analogous to the similar features of FIG. 1.

System 110 also includes second and third open center valves 142, 192, and second and third actuators 144, 192. The second and third open center valves 142, 192 are fluidly coupled to the piston pump 112 downstream of the first open center valve 114. Second and third open center valves 142, 192 are fluidly coupled to piston pump 112 via fluid coupling 118, farther downstream along fluid coupling 118 than first open center valve 114. The second and third open center valves 142, 192 are thereby also configured to receive the pressurized flow from the piston pump 112. The second and third actuators 144, 194 are, illustratively, fluid cylinders in this embodiment. The second actuator 144 is fluidly coupled to the second open center valve 142, while the third actuator 194 is fluidly coupled to the third open center valve 192. The second and third open center valves 142, 192 are thereby configured to provide the pressurized flow selectively to the second and third actuators 144, 194 respectively, in a manner analogously to that of the open center valve 14 and actuator 26 in the embodiment of FIG. 1. Other embodiments, for example, may have two open center valves, two actuators, four or more open center valves, four or more actuators, and various combinations of components depicted and described herein.

In one illustrative embodiment, the pressurized flow is provided from piston pump 112 at a flow rate that is selectable from a range that is continuously variable from zero flow to a preselected maximum. The piston pump 112 may be controlled electronically, responsively to operator input instead of with load sense signals, in one illustrative embodiment. The preselected maximum of the range of flow rates may be, for example, the flow limit of the preselected piston pump. In another embodiment, the preselected maximum may include both the flow limit of piston pump 112 as well as the contribution of an auxiliary gear pump, for example, as discussed further below. The continuous variability of the flow rate allows selectable flow to each of actuators 126, 144, 194 and improves cycle times for each selected actuator among actuators 126, 144, 194 by increasing flow to one of actuators 126, 144, 194 when desired, in one illustrative embodiment. The flow to any of actuators 126, 144, 194 can also be reduced to zero when there are no functions demanding it, thereby saving power and improving cooling.

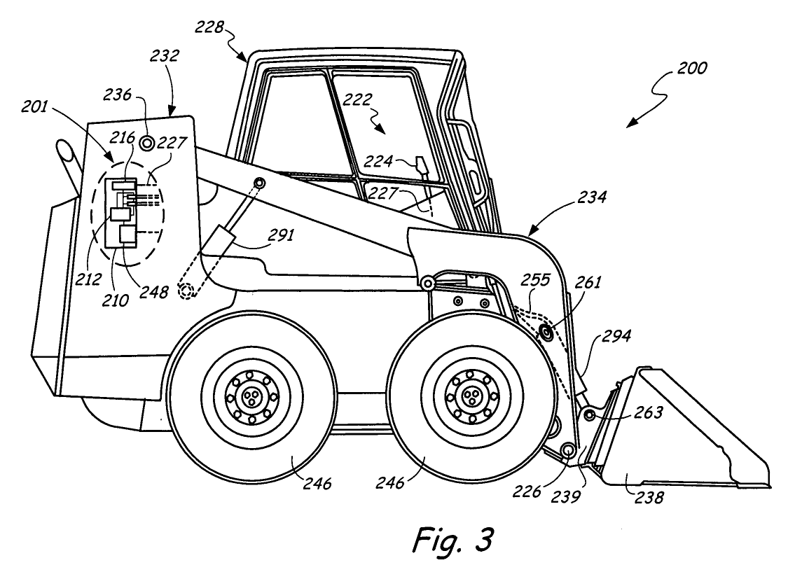

FIG. 3 is a side view, partial cutaway depiction of a power machine 200, comprising a fluid system 210, according to another illustrative embodiment. Power machine 200 also includes frame 232, and mechanical arms 234 tiltably mounted on frame 232 about pivot joints 236. Frame 232 is supported by a plurality of ground engaging members, illustratively wheels 246, in this embodiment. In another embodiment, ground engaging tracks or some other mechanism could serve as the ground engaging members for power machine 200, for example. In the illustrative embodiment of FIG. 3, power machine 200 further includes an attachment member, specifically bucket attachment 238, tiltably mounted on the mechanical arms 234 about pivot joints 226. Other types of attachment members, such as planers, backhoes, or dozer blades, may be tiltably mounted on the mechanical arms 234 in other embodiments.

Power machine 200 also includes fluid system 210, as seen in a simplified depiction in cutaway section 201. Engine 248 is part of fluid system 210 and is operably configured to provide power to the wheels 246, such as through a transmission and other known means, to power the motion of power machine 200. Engine 248 is also operably configured to provide power to a piston pump 212 comprised in fluid system 210.

Operator cab 228 is situated on frame 232 and is configured for an operator to sit within. Operator interface 222 is disposed within operator cab 228, and includes joystick 224. Operator interface 222 is electrically connected to electronic controller 216 via signal-carrying electrical line 227.

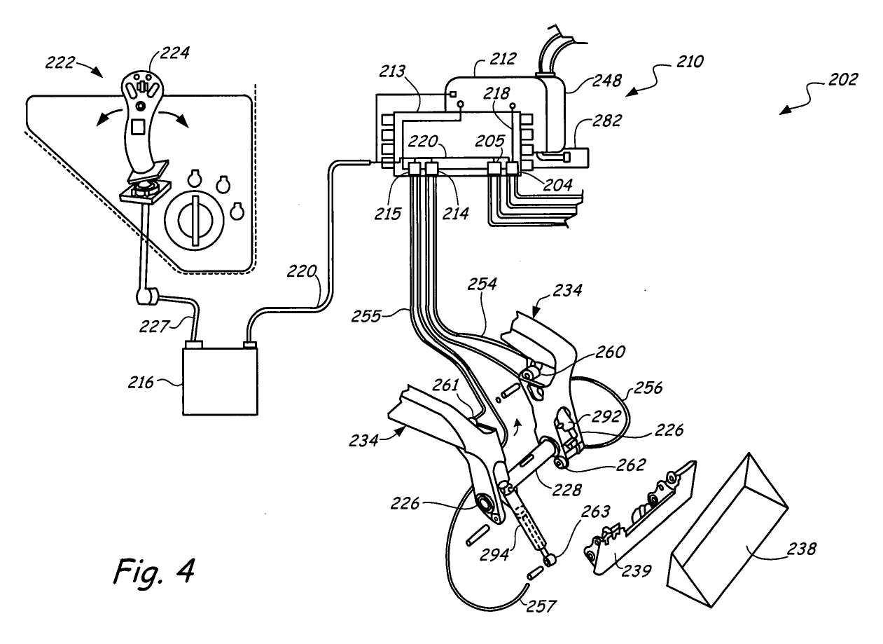

FIG. 4 is a partially schematic, fragmented, cutaway depiction of system 202, a selected set of components similar to certain components comprised in power machine 200 of FIG. 3. System 202 includes fluid system 210, mechanical arms 234, bucket attachment 238, actuators 292 and 294, electronic controller 216, and operator interface 222 including joystick 224, according to an illustrative embodiment similar to that of FIG. 3. The entire power machine 200 is one embodiment of the present invention, while the selected set of components defined as system 202 is another illustrative embodiment. Fluid system 210 by itself comprises yet another illustrative embodiment, while other illustrative embodiments include other systems of selected components.

Fluid system 210 includes components analogous to those discussed above with relation to system 10 of FIG. 1. For example, fluid system 210 includes piston pump 212, engine 248, and valve block 213, which includes open center valves 204, 205, 214 and 215. These components of fluid system 210 may be connected to frame 232 (depicted in FIG. 3) in one illustrative embodiment. Operator interface 222 and electronic controller 216 are also connected to fluid system 210, and may be connected to frame 232 (depicted in FIG. 3) in one illustrative embodiment. The engine 248 is engagingly connected to the piston pump 212 to drive the piston pump 212. Piston pump 212 is configured to provide a pressurized flow along downstream fluid coupling 218. Open center valves 204, 205, 214 and 215 are fluidly coupled to piston pump 212 via fluid coupling 218. Open center valve 205 is coupled to piston pump 212 downstream of open center valve 204; likewise, open center valve 214 is coupled downstream of valve 205, and open center valve 215 is coupled downstream of valve 214, in this illustrative embodiment. Open center valves 204, 205, 214 and 215 are thereby configured to receive pressurized flow from piston pump 212. Other numbers of valves, including additional types of valves that do not conform to the description herein of open center valves, may be included in other embodiments.

System 202 also includes first actuator 292 and second actuator 294, analogous to actuator 26 of system 10 as described above. For example, first actuator 292 is fluidly coupled to first open center valve 214, via fluid lines 254, 256 coupled to ports 260, 262 respectively on first actuator 292. First open center valve 214 is thereby configured to provide the pressurized flow selectively to the first actuator 292, in this embodiment. Similarly, second actuator 294 is fluidly coupled to second open center valve 215, via fluid lines 255, 257 coupled to ports 261, 263 respectively on second actuator 294. Second open center valve 215 is thereby configured to provide the pressurized flow selectively to the second actuator 294.

First actuator 292 and second actuator 294 are hydraulic fluid cylinders, in this illustrative embodiment. Other embodiments may include other types of actuators, such as pneumatic cylinders driven by a fluid system incorporating pneumatic components, for example. First actuator 292 and second actuator 294 are mounted between the mechanical arms 234 and the bucket attachment 238. Bucket attachment 238 is tiltably mounted on mechanical arms 234 about pivot joints 226, which are connected to each other by pivot crossbar 228. In this embodiment, attachment plate 239 is directly attached to mechanical arms 234 and actuators 292, 294, and bucket attachment 238 is mounted on attachment plate 239, thereby effecting bucket attachment 238 being tiltably mounted on mechanical arms 234 about pivot joints 226. Attachment plate 239 in itself is also an illustrative attachment member tiltably mounted on mechanical arms 234. Still other types of attachment members, such as planers, backhoes, or dozer blades, for example, can be similarly tiltably mounted on mechanical arms 234, in various embodiments. The pressurized flow to the first actuator 292 and second actuator 294, as controlled by open center valves 214 and 215, respectively, drives the bucket attachment 238 selectively to tilt one way or the other about pivot joints 226.

Similarly, following the depiction in FIG. 3, actuator 291 (and a corresponding actuator (not depicted) on the opposite side of power machine 200) are mounted between the frame 232 and the mechanical arms 234, and are in fluid communication with open center valves 204, 205 (depicted in FIG. 4) of fluid system 210. The pressurized flow to the actuator 291, and the corresponding actuator on the opposite side of power machine 200, drives mechanical arms 234 selectively to lift or lower about the pivot joints 236.

In another embodiment, a single open center valve may be used to supply the flow to both actuators 292, 294 mounted between mechanical arms 234 and bucket attachment 238, while another single open center valve may be used to supply the flow to both actuator 291 and its corresponding actuator (not depicted) mounted between frame 232 and mechanical arms 234. In still another embodiment, a fluid system could include only a single actuator fluidly coupled to an open center valve. The one actuator may be tiltably mounted on a pair of mechanical arms, or a single mechanical arm, in various embodiments. Similarly, a single open center valve may be used to supply flow to a pair of actuators mounted between a frame and a pair of mechanical arms, or between a frame and a single, unpaired mechanical arm, to drive the mechanical arms or arm selectively to lift or lower about the pivot joints, in various embodiments.

The selective tilting of bucket attachment 238 about pivot joints 226, and the selective lifting and lowering of mechanical arms 234 about the pivot joints 236, are selective in that an operator selects when and how to tilt, lift and lower, respectively, in this illustrative embodiment. The operator may selectively manipulate operator interface 222, such as by manipulating joystick 224, to send control signals along signal-carrying electrical connection 227 to electronic controller 216, in this illustrative embodiment. Electronic controller 216 is thereby configured to receive the operator input through operator interface 222, in this illustrative embodiment. Electronic controller 216 is also electrically connected to piston pump 213 and to open center valves 204, 205, 214 and 215, in this illustrative embodiment. Electronic controller 216 is thereby configured to provide the pressurized flow from piston pump 212 to open center valves 204, 205, 214 and 215 responsively to the input from the operator, in this illustrative embodiment. The flow rate, at which the electronic controller is configured to provide the pressurized flow to open center valves 204, 205, 214 and 215, is selectable from a range that is continuously variable from zero flow to a preselected maximum, in this illustrative embodiment. The maximum is preselected in that the piston pump 212 was selected with a specific, rated maximum flow rate, and was selected for inclusion in system 202 previous to normal operation by an operator, in this illustrative embodiment. The continuous variability of the available flow rates improves cycle times, for instance for attachment lift or tilt cycle times, and allows selectable flow to each of one or more actuators, such as actuators 291 (and its corresponding actuator), 292 and 294, for example. The flow can also be reduced to zero when there are no functions demanding it, thereby saving power and improving cooling.

In another illustrative embodiment, a fluid system includes one or more additional open center valves, beyond open center valves 204, 205, 214 and 215, and one or more additional corresponding actuators, beyond actuators 291 (and its corresponding actuator), 292 and 294. In such an embodiment, the additional open center valves may also be fluidly coupled to the piston pump 212, and configured thereby to receive the pressurized flow from the piston pump 212. An illustrative one of the additional actuators may be fluidly coupled to a corresponding one of the additional open center valves, so that the additional open center valve is configured to provide the pressurized flow from the piston pump 212 selectively to the corresponding additional actuator. In another illustrative embodiment, such a fluid system may include other valve types that do not correspond to the illustrative open center valves 214, 242 as disclosed herein, and may further include additional actuators that receive the pressurized flow from fluid pump 212 through such other valve types, for example. This illustrative embodiment may also include an auxiliary attachment, in addition to the attachment member 238. The auxiliary attachment could be another bucket, a shovel, or a hammer, for example. One of the additional actuators may be mounted to the auxiliary attachment, in this embodiment, such that the pressurized flow to the respective additional actuator selectively drives the auxiliary attachment within a range of motion, such as a degree of lift or tilt, for example.

In another illustrative embodiment, a fluid system includes a second pump, fluidly coupled to valve block 213 and open center valves 204, 205, 214 and 215, or additional open center valves. In this illustrative embodiment, the second pump may be configured to provide a pressurized flow to the open center valves 204, 205, 214 and 215. For example, one embodiment may include a gear pump, in addition to the piston pump, disposed to pressurize a flow going into piston pump 212, thereby increasing the maximum flow rate available, such as the preselected maximum flow rate. The gear pump would thereby further contribute to providing the pressurized flow to open center valves 204, 205, 214 and 215.

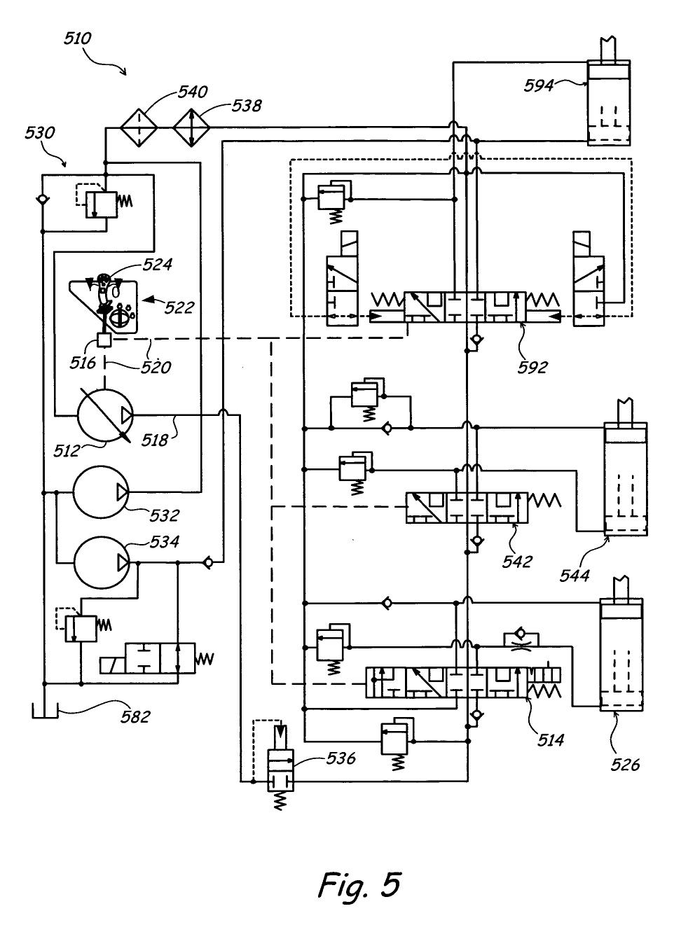

FIG. 5 depicts another illustrative embodiment, system 510. System 510 is analogous in some ways to the systems depicted in the previous figures and described with respect to the previously discussed embodiments. System 510 includes piston pump 512; open center valves 514, 542 and 592; electronic controller 516; downstream fluid coupling 518; electrical connection 520, operator interface 522, joystick 524, actuators 526, 544 and 594; and oil reservoir 582, disposed with respect to each other in a manner analogous to the similar features of FIG. 1. Electrical connection 520 is depicted in broadly dashed lines in FIG. 5. Pilot lines are depicted in finely dashed lines in FIG. 5.

System 510 further includes additional advantageous components useful for some applications of various embodiments, as will be appreciated by those skilled in the art from FIG. 5 and the rest of the present disclosure. Pressurized inlet 530 prepares fluid flow for piston pump 512, in this illustrative embodiment. Charge pump 532 feeds flow into pressurized inlet 530. High flow pump 534 is also included. Flow control valve 536 ensures that the fluid flow has a minimum pressure for lubrication. Cooler 538 cools the fluid flow, and filter 540 filters the fluid flow through the downstream fluid coupling 546 leading from the open center valves 514, 542 and 592, in this illustrative embodiment. Additional components, such as flow control valves and check valves, and the advantages of their arrangement in system 510, will be appreciated by those skilled in the art.

The piston pump 512 of system 510 is configured to provide a pressurized flow along fluid coupling 518, leading through open center valves 514, 542 and 592, to downstream fluid coupling 546, to pressurized inlet 530, and back to piston pump 512. Open center valves 514, 542 and 592 are thereby fluidly coupled to piston pump 512, and configured thereby to receive the pressurized flow from piston pump 512, in this illustrative embodiment. Electronic controller 516 is electrically connected to operator interface 522, piston pump 512, and open center valves 514, 542 and 592, via signal-carrying electrical connections 520. Electronic controller 516 is thereby configured to receive operator input from operator interface 522, such as a signal generated by proportional angular displacement of joystick 524. Electronic controller 516 is configured to electronically control piston pump 512 responsively to the operator input thus received from operator interface 522, to provide the pressurized flow to open center valves 514, 542 and 592. Electronic controller 516 is configured to provide this flow at a flow rate that is selectable from a range that is continuously variable from zero to a preselected maximum, such as described above.

Although the present invention has been described with reference to preferred embodiments, workers skilled in the art will recognize that changes may be made in form and detail without departing from the spirit and scope of the invention.

What is claimed is:

1. A system comprising:
a piston pump, configured to provide a pressurized flow;
a first open center valve, fluidly coupled to the piston pump and configured thereby to receive the pressurized flow from the piston pump; and
an electronic controller, electrically connected to the piston pump, configured to receive operator input and to electronically control the piston pump, responsively to the input, to provide the pressurized flow to the first open center valve at a flow rate that is selectable from a range that is continuously variable from zero flow to a preselected maximum.

2. The system of claim 1, wherein the flow rate of the pressurized flow provided by the piston pump is selectably controlled exclusively through the electronic controller.

3. The system of claim 1, wherein the flow rate of the pressurized flow provided by the piston pump is selectably controlled exclusively as a function of the operator input.

4. The system of claim 1, wherein the electronic controller is configured to receive the operator input through an operator interface that comprises a joystick.

5. The system of claim 1, further comprising a first actuator fluidly coupled to the first open center valve, wherein the first open center valve is configured to provide the pressurized flow selectively to the first actuator.

6. The system of claim 5, wherein the actuator is a fluid cylinder.

7. The system of claim 5, further comprising:
a frame; and
a mechanical arm tiltably mounted on the frame about a pivot joint;
wherein the first actuator is mounted between the frame and the mechanical arm, and the pressurized flow to the first actuator drives the mechanical arm selectively to lift or lower about the pivot joint.

8. The system of claim 5, further comprising:
a mechanical arm; and
an attachment member tiltably mounted on the mechanical arm about a pivot joint;
wherein the first actuator is mounted between the mechanical arm and the attachment member, and the pressurized flow to the first actuator drives the attachment member selectively to tilt one way or the other about the pivot joint.

9. The system of claim 8, wherein the attachment member comprises a bucket.

10. The system of claim 5, further comprising:
a second open center valve, fluidly coupled to the piston pump downstream of the first open center valve, and configured thereby to receive the pressurized flow from the piston pump; and
a second actuator fluidly coupled to the second open center valve, wherein the second open center valve is configured to provide the pressurized flow selectively to the second actuator.

11. The system of claim 10, further comprising:
a frame;
a mechanical arm tiltably mounted on the frame about a first pivot joint;
an attachment member tiltably mounted on the mechanical arm about a second pivot joint;
wherein the first actuator is mounted between the frame and the mechanical arm, and the pressurized flow to the first actuator drives the mechanical arm selectively to lift or lower about the first pivot joint; and
wherein the second actuator is mounted between the mechanical arm and the attachment member, and the pressurized flow to the second actuator drives the attachment member selectively to tilt one way or the other about the second pivot joint.

12. The system of claim 10, further comprising:
a third open center valve, fluidly coupled to the piston pump, and configured thereby to receive the pressurized flow from the piston pump; and
a third actuator fluidly coupled to the third open center valve, wherein the third open center valve is configured to provide the pressurized flow selectively to the third actuator.

13. The system of claim 12, further comprising an auxiliary attachment, wherein the third actuator is mounted to the auxiliary attachment, and the pressurized flow to the third actuator selectively drives the auxiliary attachment within a range of motion.

14. The system of claim 1, further comprising:
a frame, to which the piston pump and the first open center valve are connected;
a plurality of ground engaging members supporting the frame; and
an engine, operably configured to provide power to the ground engaging members, and to the piston pump.

15. The system of claim 14, wherein the ground engaging members comprise wheels.

16. The system of claim 14, wherein the ground engaging members comprise tracks.

17. The system of claim 1, further comprising a second pump, fluidly coupled to the first open center valve, and configured to provide a second pressurized flow to the first open center valve.

18. A fluid system comprising:
a piston pump, configured to provide a pressurized flow;
an open center valve, fluidly coupled to the piston pump and configured thereby to receive the pressurized flow from the piston pump; and
a means for electronically controlling the piston pump, responsively to operator input, to provide the pressurized flow to the open center valve at a flow rate that is selectable from a range that is continuously variable from zero flow to a preselected maximum.

19. The fluid system of claim 18, wherein the flow rate of the pressurized flow provided by the piston pump is controlled exclusively through the electronic controller.

20. A power machine comprising:
a frame;
a plurality of ground engaging members supporting the frame;
an engine operably connected to the ground engaging members;
a piston pump connected to the frame, and driven by the engine;
an open center valve, connected to the frame and fluidly coupled to the piston pump and configured thereby to receive a pressurized flow from the piston pump; and
an electronic controller, electrically connected to the piston pump, for electronically controlling the piston pump to provide the pressurized flow to the open center valve at a flow rate that is selectable from a range that is continuously variable from zero flow to a preselected maximum.

21. The power machine of claim 20, wherein the flow rate of the pressurized flow provided by the piston pump is controlled exclusively through the electronic controller.
